(19) United States
(12) Patent Application Publication
(10) Pub. No.: US 2015/0328935 A1
(43) Pub. Date: Nov. 19, 2015

(54) Sipe Reinforcement

(71) Applicant: BRIDGESTONE AMERICAS TIRE OPERATIONS, LLC, Nashville, TN (US)

(72) Inventors: Brian D. Steenwyk, Uniontown, OH (US); Stephen M. Vossberg, Uniontown, OH (US)

(21) Appl. No.: 14/652,984

(22) PCT Filed: Dec. 19, 2013
(86) PCT No.: PCT/US13/76460

§ 371 Date: Jun. 17, 2015

Related U.S. Application Data
(60) Provisional application No. 61/740,188, filed on Dec. 20, 2012.

(51) Int. Cl. B60C 11/12; B60C 11/13; B29D 30/06; B60C 5/00

(52) U.S. Cl. CPC B60C 11/12; B60C 5/00; B60C 11/13; B29D 30/0681

(57) ABSTRACT

Provided is a tire, having a circumferential direction, an axial direction, and a radial direction, the tire comprising, a tread surface comprising a groove which defines a block; a sipe formed in the block, the sipe being defined by a depth, a width and a length each of the depth, width, and length being defined by elongated surfaces comprising, a first elongated surface, and a second elongated surface facing the first elongated surface and offset therefrom by the sipe width. The tire may comprise projections or an array of projections having any of various properties.

### TECHNICAL FIELD

The present subject matter relates generally to a tire tread pattern. More, specifically, the present subject matter relates to a tire tread pattern comprising a sipe reinforcement adapted to increase tread pattern stiffness.

### BACKGROUND

It is sometimes desirable to create tire tread components that affect the performance of the tire as it operates.

It remains desirable to develop tire tread features and methods and apparatus for the creation of tire tread feature that affect the performance of the tire as it operates.

### SUMMARY

Provided is a tire, having a circumferential direction, an axial direction, and a radial direction, the tire comprising, a tread surface comprising a groove which defines a block; a sipe formed in the block, the sipe being defined by a depth, a width and a length each of the depth, width, and length being defined by elongated surfaces comprising, a first elongated surface, and a second elongated surface facing the first elongated surface and offset therefrom by the sipe width. The tire may comprise projections or an array of projections having any of various properties.

### BRIEF DESCRIPTION OF THE DRAWINGS

FIG. 1 is a view of a tire.

FIG. 2 is close up view of the tread of a tire.

FIG. 3 is a perspective view of a section of a tire

FIG. 4a is a front view of a first embodiment of a sipe.

FIG. 4b is a side view of a first embodiment of a sipe.

FIG. 5 is front view of a second embodiment of a sipe.

FIG. 6 is a front view of a third embodiment of a sipe.

FIG. 7 is front view of a fourth embodiment of a sipe.

FIG. 8 is a front view of a fifth embodiment of a sipe.

FIG. 9 is front view of a sixth embodiment of a sipe.

FIG. 10 is a front view of a seventh embodiment of a sipe.

FIG. 11 is front view of an eighth embodiment of a sipe.

FIG. 12 is a front view of a ninth embodiment of a sipe.

### DETAILED DESCRIPTION

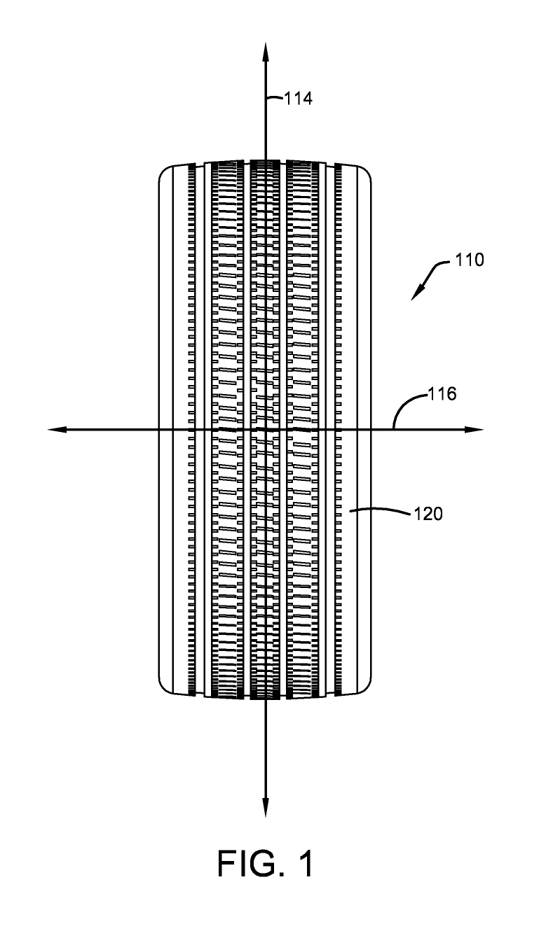

Reference will be made to the drawings, FIGS. 1-12, wherein the showings are only for purposes of illustrating certain embodiments of an apparatus and method for preparing a sample from components internal to a tire.

Referring now to FIG. 1, shown is a non-limiting implementation of a tire 110. Tire 110 is substantially cylindrical and defines a circumferential direction 114, an axial direction 116, and a radial direction (not shown). Tire 110 comprises a tire tread 120 extending around the tire 110 and extending in both the circumferential direction 114 and the axial direction 116. Tire 110 may be any sort of tire. The tire 110 may be pneumatic, non-pneumatic, run-flat, radial, or bias. The tire 110 may be a passenger tire, a light truck tire, a truck or bus tire, an agricultural tire, or other sort of tire. The tire 110 may be a cured tire, or a uncured tire. In the non-limiting implementations shown in FIG. 1, tire 110 is a pneumatic tire.

Referring now to FIG. 2, shown is a close up of a non-limiting implementation of a tire tread 220 extending in the circumferential direction 214, an axial direction 216. The tire tread 220 may comprise a first rib 221, a second rib 223, a third rib 225, a fourth rib 227, and a fifth rib 229. A rib 221, 223, 225, 227, 229 is an elongated tread feature that extends substantially circumferentially in the tire tread 220. The tire tread 220 may comprise a first groove 222, a second groove 224, a third groove 226, and a fourth groove 228. A groove 222, 224, 226, 228 is an elongated gap that extends substantially circumferentially in the tire tread 220. In some embodiments, tires may have very complex patterns in which ribs or grooves are not well defined as distinct entities. The tire tread 220 may comprise one or more sipes 230.

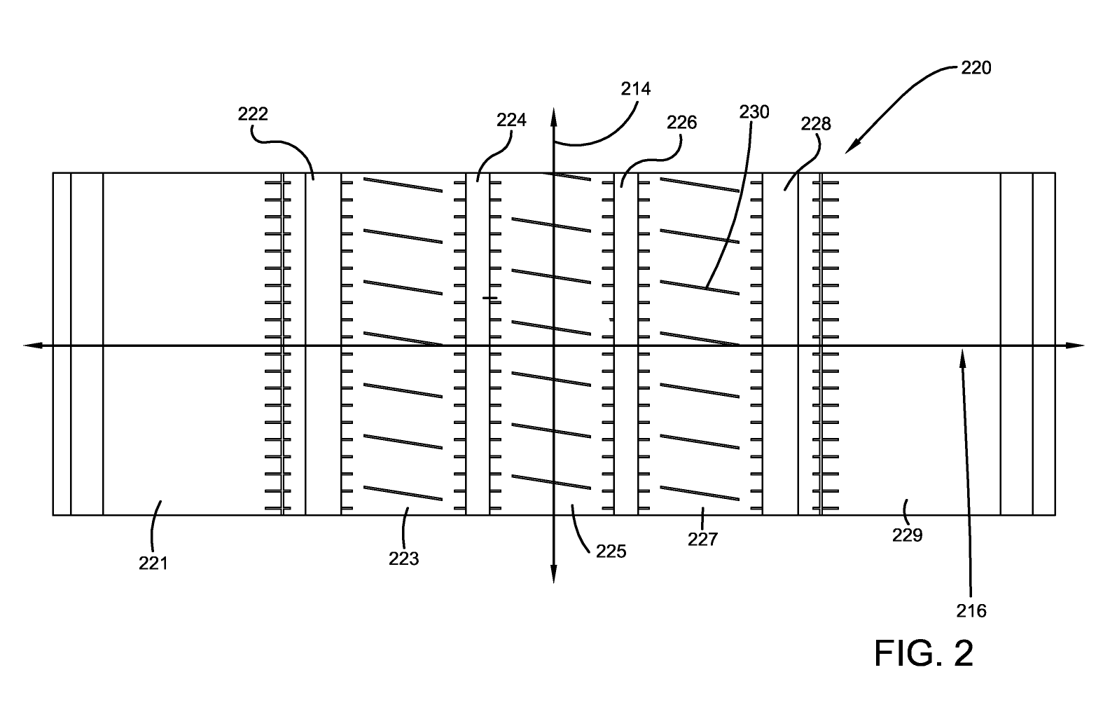

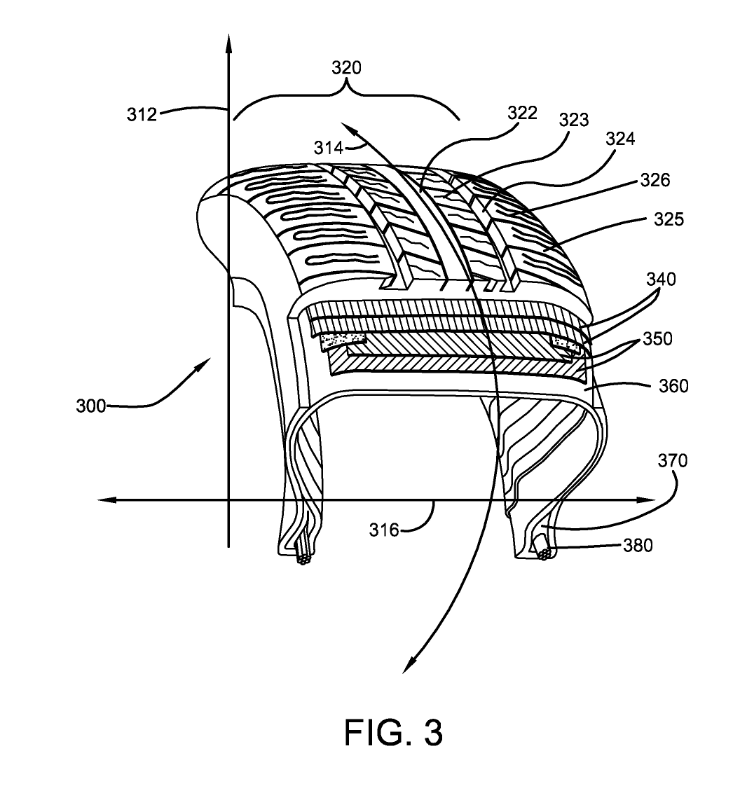

Referring now to FIG. 3, shown is a perspective view of a non-limiting implementation of a tire section 300. Tire section 300 extends partially in the circumferential direction 314, in the axial direction 316, and in the radial direction 312. The tire section 300 may comprise a tire tread 320, a first set of plies 340, a first set of belts 350, a second set of plies 360, a bead chaffer 370, and a bead 380. The tire tread 320 may comprise a rib 322, a block 323, a groove 324, a shoulder 325, and a sipe 326.

A sipe 230, 326 is very narrow gap or thin cut in the tire tread 220, 320. The width of a sipe 230, 326 is typically, between 0 and 5 millimeters wide, inclusive. As will be disclosed further herebelow, the width of a sipe 230, 326 may vary with depth or along the length of the sipe 230, 326. A sipe 230, 326 having a width of 0 mm still comprises the sipe edges, length, depth, and a shape. Further, a sipe 230, 326 having a width of 0 mm may open or permit slip or motion between the faces of the sipe during operation of the tire in which they are made. A sipe 230, 326 may have substantial depth, and may also be substantially elongated. The path of elongation described by a sipe 230, 326 may take any of a large number of forms. A sipe 230, 326 may comprise a straight shape, a curved shape, an arcuate shape, a waveform, a forking shape, or combinations thereof. As noted above, a sipe 230, 236 will have some depth.

A sipe 230, 326 may be formed by a variety of means. A sipe 230, 326 making a very thin cut a tire tread by means including thin blade, a laser, or other means chosen with good engineering judgment. A sipe 230, 326 may be formed by molding the sipe 230, 326 during formation of the tire 110 by including a sipe forming element in a tire mold (not shown). A sipe forming element may be sipe blade or other component adapted have a positive displacement having a volume and shape matching that of the desired sipe 230, 326 so that a hole left in the tire material by being displaced the sipe blade during molding has the volume and shape matching that of the desired sipe 230, 326.

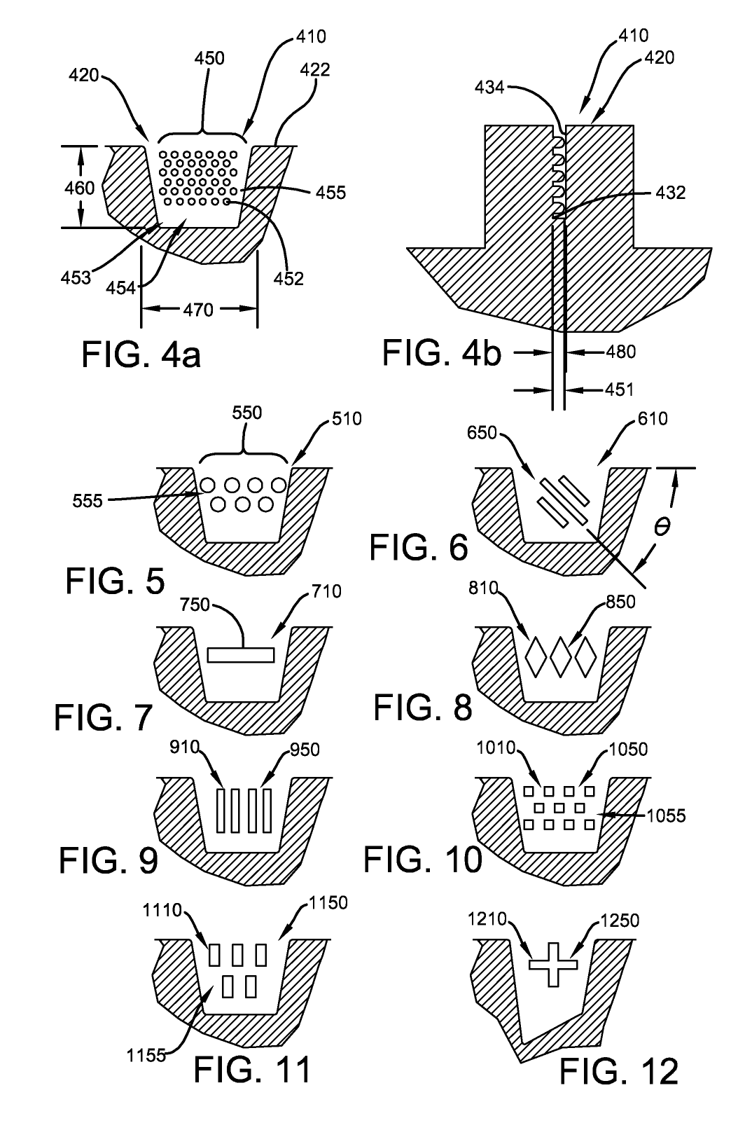

Referring now to FIGS. 4a-12, shown are a variety of cross sectional views through several differing implementations of a sipe.

FIGS. 4a and 4b show views of a first non-limiting implementation of a sipe 410. FIG. 4a shows a view through a plane parallel to the sipe length-depth plane. FIG. 4b shows a view of the first non-limiting implementation of a sipe through a plane parallel to the sipe width-depth plane. Sipe 410 is formed in a tread element 420 comprising a tread surface 422 such that the depth of sipe 410 extends into the tread element 420. Sipe 410 is defined in part by a first elongated surface 432 and in part by a second elongated surface 434. The first elongated surface 432 and the second elongated surface 434 are substantially planar, face one another, and are offset from one another by the width 480 of sipe 410. Sipe 410 comprises a plurality of projections 450 wherein each projection 452 extends from the first elongated surface 432 toward the second elongated surface 434. The plurality of projections 450 is arranged in a regular array 454 defined by five rows 455 at varying depths, each row 455 comprising a number of projections 450 where the number of projections 450 varies between rows 455. In the first, top, row 455 there are seven projections 450. In the second row 455 there are six projections 450. In the third row 455 there are seven projections 450. In the fourth row 455 there are six projections 450. In the fifth, deepest, row 455 there are five projections 450.

The regularity of array 454 is not limiting and there are acceptable alternatives to the regular array 454 shown in FIGS. 4a and 4b. In certain non-limiting implementations, the array 454 may be an irregular array 454 in which the projections 450 are arranged in any regular or repeating pattern.

The planar character of the elongated surfaces 432, 434 is not limiting and there are acceptable alternatives to the planar character of first elongated surface 432, 434 shown in FIG. 4b. In certain non-limiting implementations, one or both of the elongated surface 432, 434 may comprise curves, undulations, waves, or may otherwise be substantially non-planar.

The planar character of the second elongated surface 434 toward which the projections 450 extend is not limiting and there are acceptable alternatives to the planar character of second elongated surface 434 shown in FIG. 4b. In certain non-limiting implementations, the second elongated surface 434 may comprise one or more counter-projections extending toward one or more projections 450. In certain non-limiting implementations, the second elongated surface 434 may comprise one or more depressions or cavities into which one or more projections 450 may extend.

The substantially constant depth of sipe 410 is not limiting and there are acceptable alternatives to the substantially constant depth of sipe 410 as shown in FIG. 4a. In certain non-limiting implementations, the depth 460 of the sipe 410 may vary along the length 470 of the sipe 410.

The substantially constant projection length 451 of projections 450 is not limiting and there are acceptable alternatives to the substantially constant projection length 451 of projections 450 as shown in FIG. 4b. In certain non-limiting implementations, the projection length 451 of projections 450 may vary between projections 450. In certain non-limiting implementations, the projection length 451 of a projection 450 is a function of the position of the projection within the sipe 410; such as, without limitation as projection 450 at a first depth may differ in length from another projection 450 at a second depth.

The circular cross-sectional area 453 of projections 450 is not limiting and there are acceptable alternatives to the circular cross-sectional area 453 of projections 450 as shown in FIG. 4a. In certain non-limiting implementations, cross-sectional area 453 of projections 450 may be non-circular or vary between projections 450.

The substantially constant cross-sectional area 453 of projections 450 along the length 451 of the projections 450 is not limiting and there are acceptable alternatives to the substantially constant cross-sectional area 453 of projections 450 along the length 451 of the projections 450 as shown in FIG. 4b. In certain non-limiting implementations, the cross-sectional area 453 of projections 450 may vary along the length 451 of the projections 450. In certain non-limiting implementations, the cross-sectional area 453 of projections 450 may taper along the length 451 of the projections 450.

FIG. 5 shows a view of a second non-limiting implementation of a sipe 510 through a plane parallel to the length-depth plane of sipe 510. Sipe 510 comprises a plurality of projections 550. The plurality of projections 550 is arranged in two rows 555 at varying depths, each row 555 comprising a number of projections 550 where the number of projections 550 varies between rows 555. In the first, top, row 555 there are four projections 550. In the second, bottom, row 555 there are three projections 550.

The number of projections 550 in the rows 555 is not limiting and there are acceptable alternatives to the number of projections 550 in the rows 555 as shown in FIG. 5. In certain non-limiting implementations, number of projections in a row may be one, two, three, or more projections.

FIG. 6 shows a view of a third non-limiting implementation of a sipe 610 through a plane parallel to the length-depth plane of sipe 610. Sipe 610 comprises a plurality of projections 650. Each of the projections 650 has a cross-sectional area defined by an elongated rectangle, where the axis of elongation extends at some angle to the width-length plane of sipe 610. The rectangular character of the cross-section of the projections 650 is not limiting and other elongated shapes may be equally acceptable.

FIG. 7 shows a view of a fourth non-limiting implementation of a sipe 710 through a plane parallel to the length-depth plane of sipe 710. Sipe 710 comprises a projection 750. Projection 750 has a cross-sectional area defined by an elongated rectangle, where the axis of elongation extends substantially parallel to the width-length plane of sipe 710. The rectangular character of the cross-section of the projection 750 is not limiting and other elongated shapes may be equally acceptable.

FIG. 8 shows a view of a fifth non-limiting implementation of a sipe 810 through a plane parallel to the length-depth plane of sipe 810. Sipe 810 comprises a plurality of projections 850. Each of the projections 850 has a cross-sectional area defined by an elongated rhombus, where the axis of elongation extends parallel to the width-depth plane of sipe 810. The shape of the cross-section of the projections 850 is not limiting and other elongated shapes may be equally acceptable.

FIG. 8 shows a view of a sixth non-limiting implementation of a sipe 910 through a plane parallel to the length-depth plane of sipe 910. Sipe 910 comprises a plurality of projections 950. Each of the projections 950 has a cross-sectional area defined by an elongated rectangle, where the axis of elongation extends parallel to the width-depth plane of sipe 910. The shape of the cross-section of the projections 950 is not limiting and other elongated shapes may be equally acceptable.

FIG. 10 shows a view of a seventh non-limiting implementation of a sipe 1010 through a plane parallel to the length-depth plane of sipe 1010. Sipe 1010 comprises a plurality of projections 1050. Each of the projections 1050 has a cross-sectional area defined by a square. The plurality of projections 1050 is arranged in three rows 1055 at varying depths, each row 1055 comprising a number of projections 1050 where the number of projections 1050 varies between rows 1055. In the first, top, row 1055 there are four projections 1050. In the second row 1055 there are three projections 1050. In the third, bottom, row 1055 there are four projections 1050. The number of projections 1050 in the rows 1055 is not limiting and there are acceptable alternatives to the number of projections 1050 in the rows 1055 as shown in FIG. 10. In certain non-limiting implementations, number of projections in a row may be one, two, three, or more projections. The square character of the cross-section of the projections 1050 is not limiting and other shapes may be equally acceptable.

FIG. 11 shows a view of an eighth non-limiting implementation of a sipe 1110 through a plane parallel to the length-depth plane of sipe 1110. Sipe 1110 comprises a plurality of projections 1150. Each of the projections 1150 has a cross-sectional area defined by an elongated rectangle, where the axis of elongation extends parallel to the width-depth plane of sipe 1110. The plurality of projections 1150 is arranged in two rows 1155 at varying depths, each row 1155 comprising a number of projections 1150 where the number of projections 1150 varies between rows 1155. In the first, top, row 1155 there are three projections 11050. In the second, bottom, row 1155 there are two projections 1150. The number of projections 1150 in the rows 1155 is not limiting and there are acceptable alternatives to the number of projections 1150 in the rows 1155 as shown in FIG. 11. In certain non-limiting implementations, number of projections in a row may be one, two, three, or more projections. The rectangular character of the cross-section of the projections 1150 is not limiting and other shapes may be equally acceptable.

FIG. 12 shows a view of a ninth non-limiting implementation of a sipe 1210 through a plane parallel to the length-depth plane of sipe 1210. Sipe 1210 comprises a projection 1250. Projection 1250 has a cruciform cross-sectional area. The cruciform character of the cross-section of the projection 1250 is not limiting and other shapes may be equally acceptable. The depth of sipe 1250 may vary along the length of sipe 1250.

Referring now to FIGS. 4a-12, a projection 450, 550, 650, 750, 850, 950, 1050, 1150, 1250 may act to reinforce the sipe during operation of the tire. Without wishing to be limited to any particular process or theory, as a tire 110 rolls part of the tread 120 passes through a footprint of the tire 110. As a sipe 410, 510, 610, 710, 810, 910, 1010, 1110, 1210 in a tire tread 120 passes through a footprint of the tire 110, it may be at least partially and/or temporarily deformed such that a projection 450, 550, 650, 750, 850, 950, 1050, 1150, 1250 may engage with or disengage from another component of the sipe and thereby affect the mechanical performance of the sipe. As the tire 110 undergoes wear, the upper regions of a sipe 410, 510, 610, 710, 810, 910, 1010, 1110, 1210 may be removed by wear process such that the performance of the sipe 410, 510, 610, 710, 810, 910, 1010, 1110, 1210 may also change.

While the sipe reinforcement has been described above in connection with certain embodiments, it is to be understood that other embodiments may be used or modifications and additions may be made to the described embodiments for performing the same function of the sipe reinforcement without deviating therefrom. Further, the sipe reinforcement may include embodiments disclosed but not described in exacting detail. Further, all embodiments disclosed are not necessarily in the alternative, as various embodiments may be combined to provide the desired characteristics. Variations can be made by one having ordinary skill in the art without departing from the spirit and scope of the sipe reinforcement. Therefore, the sipe reinforcement should not be limited to any single embodiment, but rather construed in breadth and scope in accordance with the recitation of the attached claims.

What is claimed is:

1-15. (canceled)

16. A tire comprising:
a circumferential direction; an axial direction; and, a radial direction;
a tread having a tread surface comprising: (1) a groove that defines a block; and, (2) a sipe formed in the block, the sipe having a depth, a width and a length;
wherein the sipe is defined by a first elongated surface, and a second elongated surface facing the first elongated surface and offset therefrom by the sipe width; and,
wherein at least one projection extends from the first elongated surface.

17. The tire of claim 16 wherein one of the first and second elongated surfaces is substantially planar and the other of the first and second elongated surfaces is substantially non-planar.

18. The tire of claim 16 wherein the at least one projection is tapered along its length.

19. The tire of claim 16 wherein the at least one projection extends into a cavity formed in the second elongated surface.

20. The tire of claim 16 wherein:
the sipe defines a width-length plane;
the at least one projection has a cross-sectional area defined by an elongated rectangle having an axis of elongation; and,
the axis of elongation extends substantially parallel to the width-length plane of sipe.

21. The tire of claim 16 wherein:
the sipe defines a width-depth plane;
the at least one projection has a cross-sectional area defined by an elongated rectangle having an axis of elongation; and,
the axis of elongation extends substantially parallel to the width-depth plane of sipe.

22. The tire of claim 16 wherein:
the sipe defines a width-depth plane;
the at least one projection has a cross-sectional area defined by an elongated rhombus having an axis of elongation; and,
the axis of elongation extends substantially parallel to the width-depth plane of sipe.

23. The tire of claim 16 wherein the at least one projection has a cross-sectional area defined by a cruciform.

24. A tire comprising:
a circumferential direction; an axial direction; and, a radial direction;
a tread having a tread surface comprising: (1) a groove that defines a block; and, (2) a sipe formed in the block, the sipe having a depth, a width and a length;
wherein the sipe is defined by a first elongated surface, and a second elongated surface facing the first elongated surface and offset therefrom by the sipe width; and,
wherein a plurality of projections extend from the first elongated surface.

25. The tire of claim 24 wherein at least one of:
(1) a number of the projections increases with the depth of the sipe; and,
(2) a number of the projections decreases with the depth of the sipe.

26. The tire of claim 24 wherein the plurality of projections are arranged in a regular array.

27. The tire of claim 24 wherein the plurality of projections are arranged in an irregular array.

28. The tire of claim 24 wherein the plurality of projections are arranged in a single row.

29. The tire of claim 24 wherein:
the plurality of projections are arranged into at least first and second rows; and,
the first row has more projections than the second row.

30. The tire of claim 24 wherein the plurality of projections have the same cross-sectional shape.

31. The tire of claim 24 wherein the plurality of projections have the same cross-sectional area.

32. A method of making a tire comprising the steps of:
(A) providing a tire having: a circumferential direction; an axial direction; a radial direction; and, a tread;
(B) providing the tread with a tread surface having at least one groove that defines at least one block;
(C) forming at least one sipe in the block; wherein the sipe has a depth, a width and a length;
wherein the sipe is defined by a first elongated surface and a second elongated surface facing the first elongated surface and offset therefrom by the sipe width; and, wherein at least one projection extends from the first elongated surface.

33. The method of claim 32 wherein step (C) comprises the step of:
forming the at least one sipe with a laser.

34. The method of claim 32 wherein step (C) comprises the step of:
forming the at least one sipe with a sipe forming element positioned in a tire mold.

35. The method of claim 32 wherein step (C) comprises the step of:
forming a plurality of projections to extend from the first elongated surface.
